(19) United States
(12) Patent Application Publication
(10) Pub. No.: US 2015/0148074 A1
(43) Pub. Date: May 28, 2015

(54) METHOD AND APPARATUS FOR PROXIMITY-BASED SERVICE

(71) Applicant: Nokia Solutions and Networks Oy, Espoo (FI)

(72) Inventors: Vinh Van PHAN, Oulu (FI); Ling YU, Oulu (FI); Kari Veikko HORNEMAN, Oulu (FI); Klaus HUGL, Wien (AT)

(73) Assignee: NOKIA SOLUTIONS AND NETWORKS OY, Espoo (FI)

(21) Appl. No.: 14/092,121

(22) Filed: Nov. 27, 2013

(51) Int. Cl. H04W 4/02

(52) U.S. Cl. CPC H04W 4/021
USPC 455/456.3

(57) ABSTRACT

A method and apparatus may be configured to monitor a first channel allocated to proximity-based services within a cluster. The method may also include transmitting, if the user device is not receiving transmissions on the first channel, an indication that the receiving user device is not receiving transmissions on the first channel allocated to the proximity-based services within the cluster. The method may also include receiving an indication of a second channel allocated to the proximity-based services within the cluster.

### FIELD

Embodiments of the invention relate to proximity-based service.

### BACKGROUND

Proximity-based or location-based services or applications are accessible with (mobile) user devices through (mobile) communications networks. Typically, these services or applications utilize information on the geographical position of a user device. Examples of proximity-based services are device-to-device communications (D2D) or proximity-services (ProSe). Proximity-based services are expected to become a key feature to be supported by next generation (mobile) communications networks. Proximity-based services may be used to provide new service opportunities and/or reduce load caused to a network node. The proximity-based services may also be used for public safety purposes.

For proximity-based services, user devices may create a cluster or group of devices. The cluster may control the usage of resources within the cluster, for instance, resources allocated to the cluster by a network node. Additionally, a cluster head may be assigned to the cluster. The cluster head may be responsible for the resource usage control and it may communicate with the network node for the cluster.

### SUMMARY

In a first embodiment, a method may include monitoring, by a receiving user device, a first channel allocated to proximity-based services within a cluster. The method may also include transmitting, if the user device is not receiving transmissions on the first channel, an indication that the receiving user device is not receiving transmissions on the first channel allocated to the proximity-based services within the cluster. The method may also include receiving an indication of a second channel allocated to the proximity-based services within the cluster.

In a second embodiment, an apparatus may include at least one processor. The apparatus may also include at least one memory including computer program code. The at least one memory and the computer program code may be configured, with the at least one processor, to cause the apparatus at least to monitor a first channel allocated to proximity-based services within a cluster. The apparatus may also be caused to transmit, if the apparatus is not receiving transmissions on the first channel, an indication that the receiving user device is not receiving transmissions on the first channel allocated to the proximity-based services within the cluster. The apparatus may also be caused to receive an indication of a second channel allocated to the proximity-based services within the cluster.

In a third embodiment, a computer program product may be embodied on a non-transitory computer readable medium. The computer program product may be configured to control a processor to perform a process including monitoring a first channel allocated to proximity-based services within a cluster. The process may also include transmitting, if the user device is not receiving transmissions on the first channel, an indication that the receiving user device is not receiving transmissions on the first channel allocated to the proximity-based services within the cluster. The process may also include receiving an indication of a second channel allocated to the proximity-based services within the cluster.

In a fourth embodiment, a method may include receiving an indication that a receiving user device is not receiving transmissions on a channel allocated for proximity-based services within a cluster. The method may also include monitoring the channel allocated for the proximity-based services within a cluster and whether the channel is not usable for the receiving user device. The method may also include providing relaying services for proximity-based service transmissions to the receiving user device.

In a fifth embodiment, an apparatus may include at least one processor. The apparatus may also include at least one memory including computer program code. The at least one memory and the computer program code may be configured, with the at least one processor, to cause the apparatus at least to receive an indication that a receiving user device is not receiving transmissions on a channel allocated for proximity-based services within a cluster. The apparatus may also be caused to monitor the channel allocated for the proximity-based services within a cluster and whether the channel is not usable for the receiving user device. The apparatus may also be caused to provide relaying services for proximity-based service transmissions to the receiving user device.

In a sixth embodiment, a computer program product may be embodied on a non-transitory computer readable medium. The computer program product may be configured to control a processor to perform a process including receiving an indication that the receiving user device is not receiving transmissions on a channel allocated for proximity-based services within a cluster. The process may also include monitoring the channel allocated for the proximity-based services within a cluster and whether the channel is not usable for the receiving user device. The process may also include providing relaying services for proximity-based service transmissions to the receiving user device.

The features and functions that have been discussed can be achieved independently in various embodiments or may be combined in yet other embodiments further details of which can be seen with reference to the following description and drawings.

### BRIEF DESCRIPTION OF THE DRAWINGS

Some embodiments of the present invention are described below, by way of example only, with reference to the accompanying drawings, in which:

FIG. 1 illustrates an example of coverage issues for proximity-based communication.

FIG. 2 illustrates an exemplifying flowchart of a method in accordance with embodiments of the invention.

FIG. 3 illustrates an exemplifying flowchart of a method in accordance with embodiments of the invention.

FIG. 4 illustrates an example of an apparatus in accordance with embodiments of the invention.

FIG. 5 illustrates an example of an apparatus in accordance with embodiments of the invention.

FIG. 6 illustrates an example of an apparatus in accordance with embodiments of the invention.

FIG. 7 illustrates an example of an apparatus in accordance with embodiments of the invention.

FIG. 8 illustrates an example of an apparatus in accordance with embodiments of the invention.

### DETAILED DESCRIPTION

Embodiments of the invention relate to proximity-based services. Proximity-based services may comprise device-to-device (D2D) services, proximity services (ProSe) or other location-based services.

In the following, different exemplifying embodiments will be described using, as a non-limiting example of an access architecture to which the embodiments may be applied, a radio access architecture based on long term evolution advanced (LTE Advanced, LTE-A). Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

The contributions of 3GPP RAN 1 Meeting #74 (RAN 1#74) and 3GPP RAN 2 Meeting #83 (RAN 2#83) have shown that a star-topology D2D cluster is an option for supporting ProSe D2D communications. A star-topology D2D cluster is a cluster that is supervised by a central device referred to as a cluster head (CH).

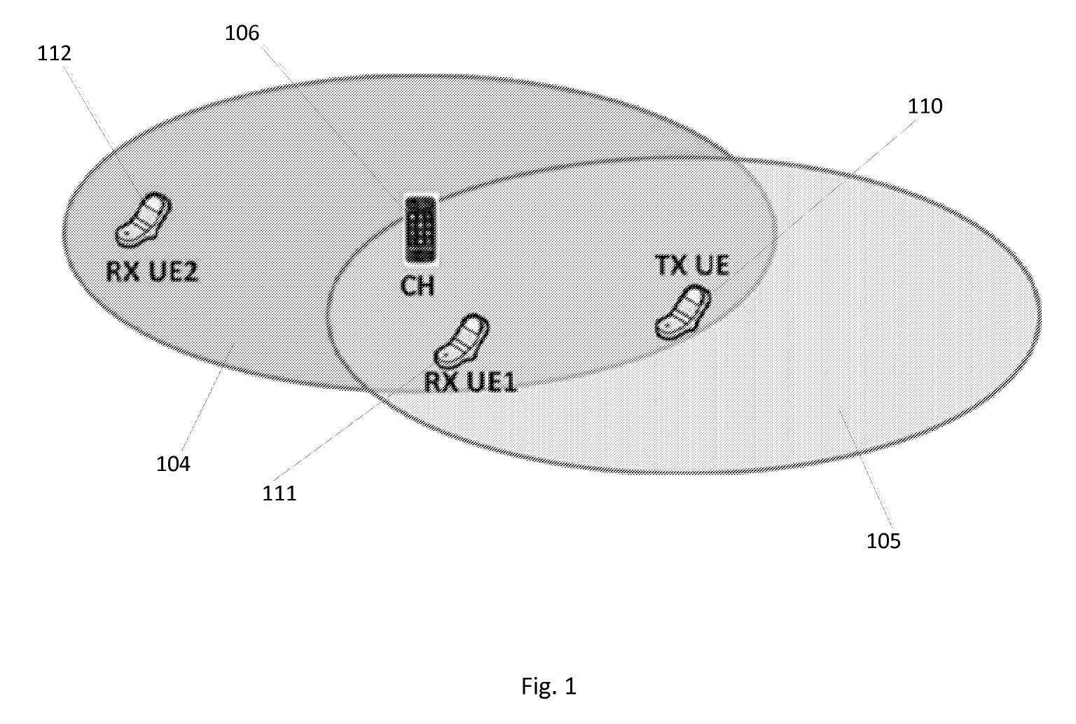

In a proximity-based service cluster, a cluster head (CH) may assume responsibility for coordinating and/or allocating channel resources for proximity-based communications between cluster members, including communication with the CH itself. Clusters may be used for group communications, such as groupcasting, broadcasting and multicasting. Transmitting real-time video in a location-based manner is one example of possible applications. A location-based group or cluster may be performed for a vehicle, shopping center, university campus, etc. A cluster head may be a user device or a network node or control entity, such as an eNode B. A user device (also called UE, user equipment, user terminal, terminal device, etc.) typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device and any device combining functionalities of a mobile phone, personal computer and/or some other digital device. It should be appreciated that two members of a cluster may be outside of D2D range from one another, and, therefore, direct D2D communication between the two members of the same cluster may not be possible. Or, even if the devices are in the D2D range of each other, other connection problems may exist, due to obstacles on the radio path or due to user device mobility, for example. FIG. 1 illustrates an example of coverage issues for proximity-based communication. As illustrated by FIG. 1, different UEs may be within the coverage area of a corresponding cluster head 106 (the coverage area indicated by coverage area 104). Transmitting (TX) UE 110 may have a coverage area corresponding to coverage area 105. A transmission from TX UE 110 may only be able to be received/decoded by cluster head (CH) 106 and receiving (RX) UE1 111 (because only CH 106 and Rx UE 1 111 are within coverage area 105). On the other hand, RX UE2 112 is within the coverage area 104 of the cluster head 106, but not in the coverage area 105 of the transmitting UE (TX UE) 110. As such, TX UE 110 is not able to communicate via D2D communications with RX UE2 112.

The above-described shortcomings create challenges when considering that direct proximity-based communications may be realized on the top of a transmitter-oriented L1 broadcast channel, without a feedback from receiver(s).

Embodiments of the present invention provide methods and apparatuses for improved operability in the case, for example, coverage issues or radio shadows take place.

It should be understood that conveying, broadcasting, groupcasting, multicasting, signalling, transmitting and/or receiving may herein mean preparing or configuring a data conveyance, broadcast, groupcast, multicast, transmission and/or reception, preparing a message to be conveyed, broadcast, groupcast, multicast, signalled, transmitted and/or received, or physical transmission and/or reception itself, etc. on a case by case basis.

In embodiments of the present invention, according to the notation used in the example of FIG. 1, a TX UE may be considered to be a transmitting member of a D2D cluster. A CH of the D2D cluster may allocate a channel “ch#i” to the Tx UE for transmission purposes. A Rx UE may be considered to be a receiving member of the D2D cluster, and the CH may configure the Rx UE to listen on the channel “ch#i” (for the transmissions of the Tx UE). There may be one or more such Rx UEs that listen to the channel “ch#i” in a group/broadcast communication. The Tx UE may or may not know that the Rx UEs are listening on the channel “ch#i.” The channel described herein may be used for resource allocation and/or for transmission of scheduling frameworks.

Embodiments of the present invention may provide a method and apparatus for performing D2D service recovery using UE-to-UE relaying via a CH. The D2D service recovery may be Rx-UE-initiated.

In one embodiment, if a CH allocates a channel ch#i to be listened to by a Rx UE, and the Rx UE listens but receives nothing for a certain pre-configured time period T1, the Rx UE may then send an indication to the CH that the Rx UE is not successfully receiving communication on the channel. Thus, the Rx UE may initiate D2D service recovery. After the indication is sent, a service-recovery timer T2 may begin to run. When performing groupcast/broadcast D2D communication, there may be more than one Rx UE which experiences such problems with channel ch#i and, therefore, more than one Rx UE may send such an indication to the CH.

The CH may then begin monitoring the channel ch#i, as indicated/requested by the Rx UE. The CH may monitor the channel ch#i for a time period corresponding to a time T, for example. T may be less than or equal to T2.

If the CH is configured to allocate the channel ch#i for different Tx UEs (as described above) or, if the CH itself is a listener of the channel ch#i, the CH may be able to readily determine whether or not there is a D2D-range-related problem between the Rx UE(s) and Tx UEs. Otherwise, if channel ch#i is allocated to the Tx UE in a semi-persistent fashion (in which the Tx UE may or may not transmit on a pre-scheduled occasion), then the CH may need to listen to channel ch#i to determine whether the channel is active or not. The CH may also more quickly determine whether a problem exists with channel ch#i based on, for example, the number of indications received/detected from cluster members on the channel.

Based on the monitoring performed by the CH on the channel ch#i, the CH may decide to provide UE-to-UE relaying of the transmission between the Tx UE and the Rx UE(s) as needed.

The CH may provide UE-to-UE relaying by allocating a new channel to relay transmission of ch#i that is either (1) generally allocated to all relevant Rx UE members or (2) to only the Rx UE(s) who have indicated a problem with channel ch#i to the CH. The first option may be preferable when performing broadcast/groupcast service, with more than one UE having a problem with the channel. The second option may be preferable for unicast or in the event that a single, isolated Rx UE has a problem with the channel.

The CH may provide UE-to-UE relay with one of the following options. The CH may also provide corresponding control signalling.

In one option, Rx UE members of a D2D cluster may monitor a first possible decodable transmission. In one embodiment, the Rx UE members may monitor only the first possible decodable transmission. Rx UE members that do not have a problem with channel ch#i may keep receiving over channel ch#i from the Tx UEs, and those RX UE members that do have the problem with the channel ch#i are configured to receive a relaying transmission from the CH. In this option, the CH may allocate a new relay channel “ch#r” to those RX UE members which have the problem with channel ch#i.

In another option, the Rx UE members of the D2D cluster may monitor and receive the relay transmission from the CH. In one embodiment, the Rx UE members monitor and receive only the relay transmission from the CH. This option may be implemented in a similar way as the previous option, with a new relay channel ch#r allocated by the CH to the relevant Rx UE members. The relevant Rx UEs may be the UEs which are addressed to receive the same groupcast/broadcast over the channel ch#i. Once new channel ch#r is allocated to the RX UEs, the RX UEs may monitor channel ch#r instead of channel ch#i. Alternatively, the CH will relay for Rx UEs of the former channel ch#i (that was used by the Tx UE), and the CH may allocate a new channel “ch#t” for the transmitting UE to transmit to CH, thus hiding UE-to-UE relay from the Rx UEs.

In yet another option, the Rx UE members may monitor both the first possible decodable transmission as well as the relay transmission from the CH. The Rx UE members may then decide whether to receive from the best one or from both for possible diversity gain. The Rx UE members may also determine the appropriate triggering to release the relay channel when UE-to-UE relay is no longer necessary. This option may also need a new relay channel ch#r applied for all relevant Rx UEs, in addition to channel ch#i. The Rx UE, which has the problem with the channel ch#i, may start receiving the new channel ch#r, but the Rx UE may still continue to monitor channel ch#i from time-to-time in a pre-configured manner. The Rx UE may monitor the channel ch#i from time-to-time so that, as soon as transmissions may be received over channel ch#i, the Rx UE will indicate this change to the CH and may return to receiving from former channel ch#i. Based on feedback from the Rx UEs requesting for relay, the CH may then release the relaying channel. To assure that the relaying channel is released, the CH may request release of channel ch#r again.

In one embodiment, T1, T2, and T may be pre-configured system parameters, which may be hard-coded into D2D UEs. T1, T2, and T may also be provided on-the-fly by the serving network (by an eNB) to all D2D UEs (in a cell), or may be provided to UEs on an individual basis.

T1 may start, for example, when an Rx UE starts monitoring channel ch#i for the next expected packet, or, alternatively, T1 may start when the Rx UE receives the initial allocation of ch#i. T1 may be reset after each packet reception.

T2 may be introduced for a specific service-recovery phase, depending on the ongoing service application. During T2, an Rx UE may keep monitoring channel ch#i, and, if the Rx UE receives some expected data in channel ch#i, then the Rx UE may send a false-alarm indication to the CH and stop T2. In case T2 expires without the Rx UE receiving any data in channel ch#i nor any control information from the CH concerning the channel ch#i, then the Rx UE may release itself from monitoring the channel ch#i. If T2 is not configured, then a false-alarm indication may be sent by the requesting Rx UE at any point of time, as long as the Rx UE keeps monitoring the channel ch#i. The CH, upon receiving the false-alarm indication from the requesting Rx UE, may also stop T and the CH may not need to carry out any further action. In case T expires at the CH, and the CH determines that channel ch#i is actually inactive, the CH may send an explicit notification that channel ch#i is inactive to the requesting Rx UE to avoid a false alarm or to release the channel ch#i from a corresponding Tx UE, Rx UE, or a group thereof. In one embodiment, to avoid the transmission of a false alarm, a Tx UE may be configured to send at least one packet, either an actual data packet or a dummy packet after every time duration T3 (where T3 is less than or equal to T1) during the life time/occupancy time of channel ch#i. In this case, T is not needed.

Additionally, depending on the requirement of the service for lossless performance, the indication sent by the Rx UE to the CH to trigger possible UE-to-UE relay may or may not include further reception status information of the channel ch#i or logical channel(s) mapped on the channel ch#i. For example, with a real-time voice-group call, lossy service recovery may be acceptable, which may, in turn, yield a reduction in recovery time. In a less error-tolerable message or data service, the indication of the Rx UE to the CH may include a sequence number of a last in-order received data packet. In this case, the CH (whether by itself or with requested cooperation from the Tx UE) should be able to buffer all missing packets. The CH may be able to relay these packets afterwards. This may be considered as one of the criteria for the CH to take into account when deciding whether UE-to-UE relay is sufficient or not sufficient to carry out.

The CH, depending on the applied relaying option, may request some modification of the channel ch#i towards the Tx UE. The Tx UE, depending on a time-shift of the relaying channel ch#r, may be able to monitor ch#r in order to decide and to carry out possible self-adjustment and retransmission for optimal and reliable operation. For example, a transport format may be adjusted, or retransmission/repetition of actual data may be carried out.

The CH may be configured to select a best relaying option, and may also be configured to decide and to carry out possible adaptive relaying operations, for example, switching between the proposed relaying options on-the-fly. The switching may be based on, for example, relevant on-the-fly requests/indications from cluster members, monitored up-to-date statuses/conditions/capabilities of the CH itself, and the cluster operation.

Embodiments may be directed to autonomous D2D communications that are realized based on hard-coded pre-configurations. Embodiments may use the self-organizing capability of D2D devices. For network-controlled D2D communications, at least some elements may be realized using possible assistance services from the network (from the serving eNB, for example). The serving eNB may be considered as a coordination point or as a master of all CHs operating inside the cell. In this regard, the serving eNB may be able to take over or provide assistance in any functions of the CH towards members using cellular access (the serving eNB may have common or dedicated control).

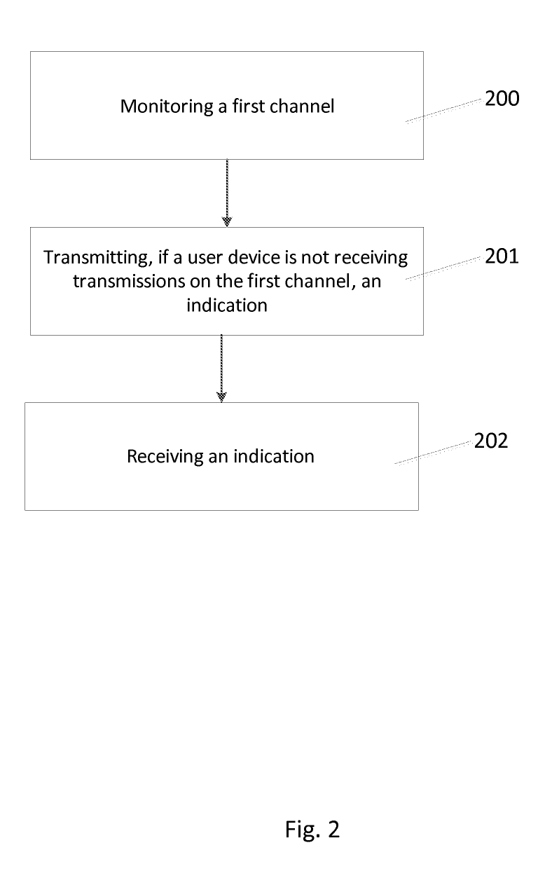

FIG. 2 illustrates an exemplifying flowchart of a method in accordance with embodiments of the invention suitable to be carried out by a user device being a target of communications or, for example, willing to receive broadcast or groupcast information.

The embodiment of FIG. 2 comprises, in block 200, monitoring a first channel allocated to proximity-based services within a cluster.

Monitoring may be carried out by listening to a channel allocated to proximity-based services by a network node or a cluster head. Additionally, a possibly poorly received signal may be analyzed, for instance, to find out error rate or other signal quality parameter(s).

In the example of FIG. 1, a TX UE may be considered to be a transmitting member of a D2D cluster. A CH of the D2D cluster may allocate a channel “ch#i” to the Tx UE for transmission purposes. A Rx UE may be considered to be a receiving member of the D2D cluster, and the CH may configure the Rx UE to listen on the channel “ch#i” (for the transmissions of the Tx UE). There may be one or more such Rx UEs that listen to the channel “ch#i” in a group/broadcast communication. The Tx UE may or may not know that the Rx UEs are listening on the channel “ch#i.” The channel described herein may be used for resource allocation and/or for transmission of scheduling frameworks.

In block 201, an indication that the receiving user device is not receiving transmissions on the first channel allocated to the proximity-based services within the cluster is transmitted, if the user device is not receiving transmissions on the first channel.

An indication that the receiving user device is not receiving transmissions on the first channel allocated to the proximity-based services within the cluster may be a message informing the bad quality of the received signal or informing that the signal could not be received at all, for example. The message may comprise one or more bits according to the current case. Transmissions may be any kind of data transmissions, such as a voice call, conference call, one or more video clips, photographs, text or multimedia messages, etc. “Receiving transmissions” may mean that transmissions are received in such a manner that they can be detected in an appropriate manner. Correspondingly, “not receiving transmissions” may mean that the quality of the received signal is so low that it cannot be detected or the transmission is not received at all, for example.

In the example of FIG. 1, if a CH allocates channel ch#i to be listened to by a Rx UE, and the Rx UE listens but receives nothing for a certain pre-configured time period T1, the Rx UE may then send an indication to the CH that the Rx UE is not successfully receiving communication on the channel. Thus, the Rx UE may initiate D2D service recovery. After the indication is sent, a service-recovery timer T2 may begin to run. When performing groupcast/broadcast D2D communication, there may be more than one Rx UE which experiences such problems with channel ch#i and, therefore, more than one Rx UE may send such an indication to the CH.

Depending on the requirement of the service for lossless performance, the indication sent by the Rx UE to the CH to trigger possible UE-to-UE relay may or may not include further reception status information of the channel ch#i or logical channel(s) mapped on the channel ch#i. For example, with a real-time voice-group call, lossy service recovery may be acceptable, which may, in turn, yield a reduction in recovery time. In a less error-tolerable message or data service, the indication of the Rx UE to the CH may include a sequence number of a last in-order received data packet. In this case, the CH (whether by itself or with requested cooperation from the Tx UE) should be able to buffer all missing packets. The CH may be able to relay these packets afterwards. This may be considered as one of the criteria for the CH to take into account when deciding whether UE-to-UE relay is sufficient or not sufficient to carry out.

In block 202, an indication of a second channel allocated to the proximity-based services within the cluster is received.

An indication of a second channel allocated to the proximity-based services within the cluster may be a message comprising channel allocation information. The second channel may be a relaying channel on which the cluster head relays or transmits information targeted to the receiving user device or groupcast/broadcast information targeted to user device in a specific geographical area, for example.

Additionally, an indication that the second channel is not needed anymore may be transmitted to a cluster head, if transmissions are received again on the first channel allocated to the proximity-based services within the cluster. The indication may be a message comprising information that the first (original) channel is heard again or detectable, or it may be a message comprising a channel release request.

In the example of FIG. 1, The CH may begin monitoring the channel ch#i, as indicated/requested by the Rx UE. The CH may monitor the channel ch#i for a time period corresponding to a time T, for example. T may be less than or equal to T2.

If the CH is configured to allocate the channel ch#i for different Tx UEs (as described above) or, if the CH itself is a listener of the channel ch#i, the CH may be able to readily determine whether or not there is a D2D-range-related problem between the Rx UE(s) and Tx UEs. Otherwise, if channel ch#i is allocated to the Tx UE in a semi-persistent fashion (in which the Tx UE may or may not transmit on a pre-scheduled occasion), then the CH may need to listen to channel ch#i to determine whether the channel is active or not. The CH may also more quickly determine whether a problem exists with channel ch#i based on, for example, the number of indications received/detected from cluster members on the channel.

Based on the monitoring performed by the CH on the channel ch#i, the CH may decide to provide UE-to-UE relaying of the transmission between the Tx UE and the Rx UE(s) as needed.

In embodiments, according to the example of FIG. 1, the CH may provide UE-to-UE relaying by allocating a new channel to relay transmission of ch#i that is either (1) generally allocated to all relevant Rx UE members or (2) to only the Rx UE(s) who have indicated a problem with channel ch#i to the CH. The first option may be preferable when performing broadcast/groupcast service, with more than one UE having a problem with the channel. The second option may be preferable for unicast or in the event that a single, isolated Rx UE has a problem with the channel.

Additionally, a receiving user device may choose a channel to monitor: the first channel allocated to the proximity-based services within the cluster or the second channel allocated to the proximity-based services within the cluster.

In another option, the user device may choose to monitor both the first channel allocated to the proximity-based services within the cluster and the second channel allocated to the proximity-based services within the cluster and then determine to use at least one of the monitored channels for reception.

In the example of FIG. 1, in one option, Rx UE members of a D2D cluster may monitor a first possible decodable transmission. In one embodiment, the Rx UE members may monitor only the first possible decodable transmission. Rx UE members that do not have a problem with channel ch#i may keep receiving over channel ch#i from the Tx UEs, and those RX UE members that do have the problem with the channel ch#i are configured to receive a relaying transmission from the CH. In this option, the CH may allocate a new relay channel “ch#r” to those RX UE members which have the problem with channel ch#i.

In another option, the Rx UE members of the D2D cluster may monitor and receive the relay transmission from the CH. In one embodiment, the Rx UE members monitor and receive only the relay transmission from the CH. This option may be implemented in a similar way as the previous option, with a new relay channel ch#r allocated by the CH to the relevant Rx UE members. The relevant Rx UEs may be the UEs which are addressed to receive the same groupcast/broadcast over the channel ch#i. Once new channel ch#r is allocated to the RX UEs, the RX UEs may monitor channel ch#r instead of channel ch#i. Alternatively, the CH will relay for Rx UEs of the former channel ch#i (that was used by the Tx UE), and the CH may allocate a new channel “ch#t” for the transmitting UE to transmit to CH, thus hiding UE-to-UE relay from the Rx UEs.

In yet another option, the Rx UE members may monitor both the first possible decodable transmission as well as the relay transmission from the CH. The Rx UE members may then decide whether to receive from the best one or from both for possible diversity gain. The Rx UE members may also determine the appropriate triggering to release the relay channel when UE-to-UE relay is no longer necessary. This option may also need a new relay channel ch#r applied for all relevant Rx UEs, in addition to channel ch#i. The Rx UE, which has the problem with the channel ch#i, may start receiving the new channel ch#r, but the Rx UE may still continue to monitor channel ch#i from time-to-time in a pre-configured manner. The Rx UE may monitor the channel ch#i from time-to-time so that, as soon as transmissions may be received over channel ch#i, the Rx UE will indicate this change to the CH and may return to receiving from former channel ch#i. Based on feedback from the Rx UEs requesting for relay, the CH may then release the relaying channel. To assure that the relaying channel is released, the CH may request release of channel ch#r again.

As to parameters T1, T2 and T, they may be pre-configured system parameters, which may be hard-coded into D2D UEs. T1, T2, and T may also be provided on-the-fly by the serving network (by an eNB) to all D2D UEs (in a cell), or may be provided to UEs on an individual basis.

T1 may start, for example, when an Rx UE starts monitoring channel ch#i for the next expected packet, or, alternatively, T1 may start when the Rx UE receives the initial allocation of ch#i. T1 may be reset after each packet reception.

T2 may be introduced for a specific service-recovery phase, depending on the ongoing service application. During T2, an Rx UE may keep monitoring channel ch#i, and, if the Rx UE receives some expected data in channel ch#i, then the Rx UE may send a false-alarm indication to the CH and stop T2. In case T2 expires without the Rx UE receiving any data in channel ch#i nor any control information from the CH concerning the channel ch#i, then the Rx UE may release itself from monitoring the channel ch#i. If T2 is not configured, then a false-alarm indication may be sent by the requesting Rx UE at any point of time, as long as the Rx UE keeps monitoring the channel ch#i. The CH, upon receiving the false-alarm indication from the requesting Rx UE, may also stop T and the CH may not need to carry out any further action. In case T expires at the CH, and the CH determines that channel ch#i is actually inactive, the CH may send an explicit notification that channel ch#i is inactive to the requesting Rx UE to avoid a false alarm or to release the channel ch#i from a corresponding Tx UE, Rx UE, or a group thereof. In one embodiment, to avoid the transmission of a false alarm, a Tx UE may be configured to send at least one packet, either an actual data packet or a dummy packet after every time duration T3 (where T3 is less than or equal to T1) during the life time/occupancy time of channel ch#i. In this case, T is not needed.

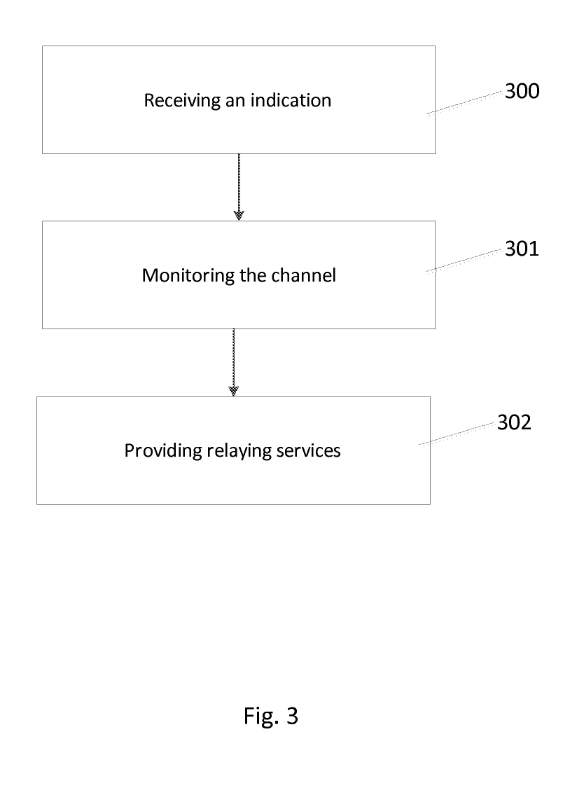

FIG. 3 illustrates an exemplifying flowchart of an embodiment suitable to be carried out by a cluster head. In some embodiments, the cluster head may be a network node, a user device, or other device associated with the network. The embodiment illustrated in FIG. 3 includes, at 300, receiving an indication that a receiving user device is not receiving transmissions on a channel allocated for proximity-based services within a cluster.

An indication that a receiving user device is not receiving transmissions on a channel allocated for proximity-based services within a cluster may be a message informing the bad quality of a received signal (received by the receiving user device) or informing that the signal could not be received at all, for example. The message may comprise one or more bits. Transmissions may be any kind of data transmissions, such as a voice call, conference call, one or more video clips, photographs, text or multimedia messages, etc. “Receiving transmissions” may mean that transmissions are received in such a manner that they can be detected in an appropriate manner. Correspondingly, “not receiving transmissions” may mean that the quality of the received signal is so low that it cannot be detected or the transmission is not received at all, for example.

The embodiment, at 301, includes monitoring the channel allocated for the proximity-based services within a cluster and whether the channel is not usable for the receiving user device.

Monitoring may be carried out by listening to the channel. Additionally, a possibly poorly received signal may be analyzed, for instance, to find out error rate or other signal quality parameter(s).

In the example of FIG. 1, as described above, the CH may begin monitoring the channel ch#i, as indicated/requested by the Rx UE. The CH may monitor the channel ch#i for the time period corresponding to the time T, for example. T may be less than or equal to T2.

If the CH is configured to allocate the channel ch#i for different Tx UEs (as described above) or, if the CH itself is a listener of the channel ch#i, the CH may be able to readily determine whether or not there is a D2D-range-related problem between the Rx UE(s) and Tx UEs. Otherwise, if channel ch#i is allocated to the Tx UE in a semi-persistent fashion (in which the Tx UE may or may not transmit on a pre-scheduled occasion), then the CH may need to listen to channel ch#i to determine whether the channel is active or not. The CH may also more quickly determine whether a problem exists with channel ch#i based on, for example, the number of indications received/detected from cluster members on the channel.

Based on the monitoring performed by the CH on the channel ch#i, the CH may decide to provide UE-to-UE relaying of the transmission between the Tx UE and the Rx UE(s) as needed.

Referring again to FIG. 3, the embodiment, at 302, includes providing relaying services for proximity-based service transmission to the receiving user device.

Relaying services may also be provided to at least one cluster member other than the receiving user device. Additionally, the providing of the relaying services may further comprise allocating a channel for the relaying services (a second channel for proximity-based services), receiving an indication that transmissions are received on the channel allocated for proximity-based services (a first channel for proximity-based services), and/or releasing the channel allocated for the relaying services. The relaying services may be provided by using groupcasting and/or broadcasting.

In the example of FIG. 1, as described above, the CH may provide UE-to-UE relaying by allocating a new channel to relay transmission of ch#i that is either (1) generally allocated to all relevant Rx UE members or (2) to only the Rx UE(s) who have indicated a problem with channel ch#i to the CH. The first option may be preferable when performing broadcast/groupcast service, with more than one UE having a problem with the channel. The second option may be preferable for unicast or in the event that a single, isolated Rx UE has a problem with the channel.

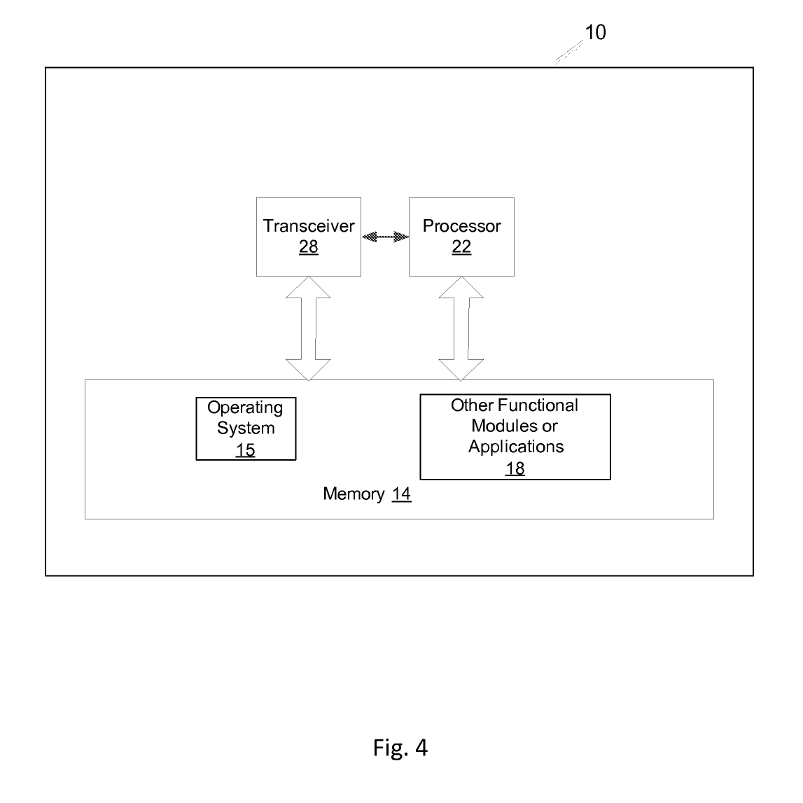

FIG. 4 illustrates an example of an apparatus in accordance with embodiments suitable to be carried out by a user device being a target of communications or, for example, willing to receive broadcasted or groupcasted information or with embodiments suitable to be carried out by a cluster head (typically a user device chosen among cluster members). Apparatus 10 may comprise a processor 22 for processing information and executing instructions or operations. Processor 22 may be any type of general or specific purpose processor. While a single processor 22 is shown in FIG. 4, multiple processors may be utilized according to other embodiments. Processor 22 may also comprise one or more of general-purpose computers, special purpose computers, microprocessors, digital signal processors (DSPs), field-programmable gate arrays (FPGAs), application-specific integrated circuits (ASICs), digital signal processing devices (DSPDs), programmable logic devices (PLDs), field programmable gate arrays (FPGAs), processors, controllers, micro-controllers, digitally enhanced circuits, single-chip computer elements, chipsets, other electronic units designed to perform the functions described herein or processors based on a multi-core processor architecture, as examples, or any combination thereof.

Apparatus 10 may further comprise at least one external and/or internal memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 comprises any combination of random access memory (RAM), read only memory (ROM), static storage such as a magnetic or optical disk, or any other type of non-transitory machine or computer readable media. The instructions stored in memory 14 may comprise program instructions or computer program code that, when executed by processor 22, enable the apparatus 10 to perform tasks as described herein.

Apparatus 10 may also comprise one or more antennas (not shown) or being coupled to a remote radio head for transmitting and/or receiving signals and/or data to and from apparatus 10. Apparatus 10 may further comprise or being coupled to a transceiver 28 that modulates information on to a carrier waveform for transmission by the antenna(s) and demodulates information received via the antenna(s) for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources. In an embodiment, memory 14 may store software modules that provide functionality when executed by processor 22. The modules may comprise an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

The apparatus may be, comprise or be associated with at least one software application, module, unit or entity configured as arithmetic operation, or as a program (including an added or updated software routine), executed by at least one operation processor. Programs, also called program products or computer programs, including software routines, applets and macros, may be stored in any apparatus-readable data storage medium and they comprise program instructions to perform particular tasks. A computer program or a computer program product may comprise one or more computer-executable components or instructions which, when run, cause any embodiment to be performed.

Functionality of each embodiment may be performed as at least one routine, which may perform transmitting and receiving as described above. Transmitting may generally comprise the sending of communication using electrical signals, electromagnetic signals, and/or optical signals. Receiving may generally comprise the receiving of the electrical signals, electromagnetic signals, and/or optical signals. For a physical transmission or reception via a radio path, the software code may comprise one or more software modules for controlling a radio receiver/transmitter or it may cooperate with a program controlling a radio receiver/transmitter.

A computer program product may be configured to control a processor to perform a process of monitoring a first channel allocated to proximity-based services within a cluster, transmitting, if the user device is not receiving transmissions on the first channel, an indication that the receiving user device is not receiving transmissions on the first channel allocated to the proximity-based services within the cluster, and receiving an indication of a second channel allocated to the proximity-based services within the cluster.

Another computer program product may be configured to control a processor to perform a process receiving an indication that a receiving user device is not receiving transmissions on a channel allocated for proximity-based services within a cluster, monitoring the channel allocated for the proximity-based services within a cluster and whether the channel is not usable for the receiving user device, and providing relaying services for proximity-based service transmissions to the receiving user device.

Embodiments provide computer programs embodied on a distribution medium, comprising program instructions which, when loaded into apparatuses, constitute the apparatuses as explained above. The distribution medium may be a non-transitory medium.

A computer program product may also be downloadable from a communication network and/or stored on a computer-readable and/or microprocessor-executable medium. The medium may be a non-transitory medium.

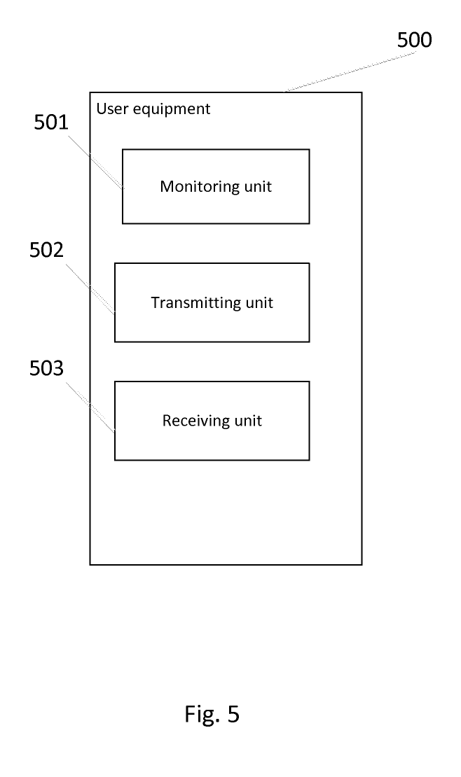

FIG. 5 illustrates an example of an apparatus in accordance with another embodiment suitable to be carried out by a user device being a target of communications or, for example, willing to receive broadcast or groupcast information. Apparatus 500 may be a user equipment or user device, for example. Apparatus 500 may comprise a monitoring unit 501 that monitors a first channel allocated to proximity-based services within a cluster. Apparatus 500 may also include a transmitting unit 502 that transmits, if the user device is not receiving transmissions on the first channel, an indication that the receiving user device is not receiving transmissions on the first channel allocated to the proximity-based services within the cluster. Apparatus 500 also includes a receiving unit 503 that receives an indication of a second channel allocated to the proximity-based services within the cluster.

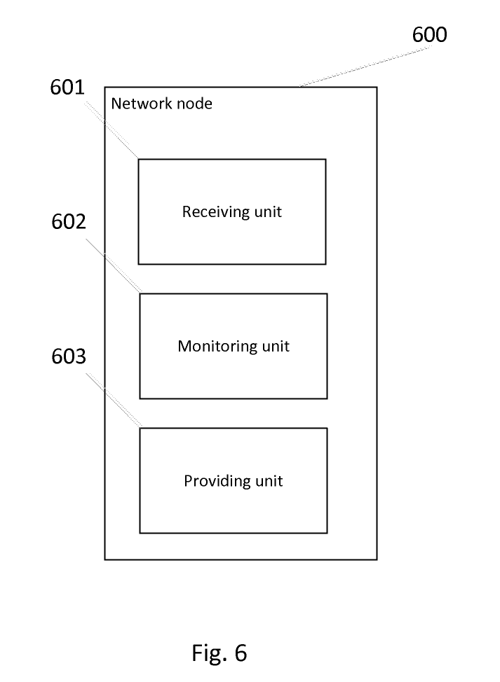

FIG. 6 illustrates an example of an apparatus in accordance with another embodiment to be carried out by a cluster head. Apparatus 600 may comprise a receiving unit 601 that receives an indication that a receiving user device is not receiving transmissions on a channel allocated for proximity-based services within a cluster. Apparatus 600 also includes a monitoring unit 602 that monitors the channel allocated for the proximity-based services within a cluster and whether the channel is not usable for the receiving user device. Apparatus 600 also includes a providing unit 603 that provides relaying services for proximity-based service transmissions to the receiving user device.

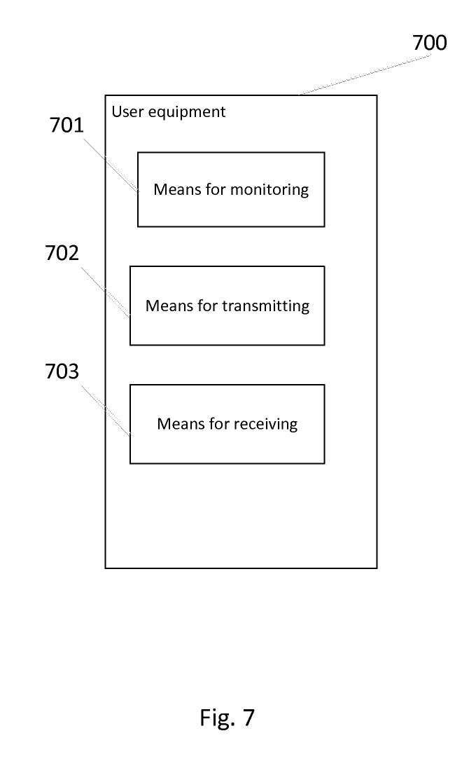

FIG. 7 illustrates an example of an apparatus in accordance with another embodiment suitable to be carried out by a user device being a target of communications or, for example, willing to receive broadcast or groupcast information. Apparatus 700 may be a user equipment or user device, for example. Apparatus 700 may comprise means 701 for monitoring a first channel allocated to proximity-based services within a cluster. Apparatus 700 may also include means 702 for transmitting, if the user device is not receiving transmissions on the first channel, an indication that the receiving user device is not receiving transmissions on the first channel allocated to the proximity-based services within the cluster. Apparatus 700 also includes means 703 for receiving an indication of a second channel allocated to the proximity-based services within the cluster.

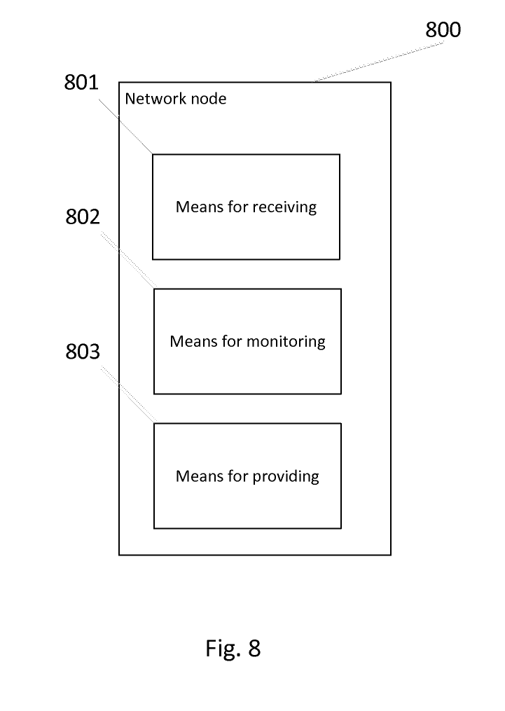

FIG. 8 illustrates an example of an apparatus in accordance with another embodiment suitable to be carried out by a cluster head. Apparatus 800 may comprise means 801 for receiving an indication that a receiving user device is not receiving transmissions on a channel allocated for proximity-based services within a cluster. Apparatus 800 also includes means 802 for monitoring the channel allocated for the proximity-based services within a cluster and whether the channel is not usable for the receiving user device. Apparatus 800 also includes means 803 for providing relaying services for proximity-based service transmissions to the receiving user device.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
monitoring, by a receiving user device, a first channel allocated to proximity-based services within a cluster;
transmitting, if the user device is not receiving transmissions on the first channel, an indication that the receiving user device is not receiving transmissions on the first channel allocated to the proximity-based services within the cluster; and
receiving an indication of a second channel allocated to the proximity-based services within the cluster.

2. The method according to claim 1, wherein the second channel allocated to the proximity-based services within the cluster is a relaying channel for transmissions of a cluster head of the cluster.

3. The method according to claim 1, wherein the indication is transmitted to a cluster head of the cluster.

4. The method according to claim 1, further comprising:
monitoring at least one of the following: the first channel allocated to the proximity-based services within the cluster and the second channel allocated to the proximity-based services within the cluster.

5. The method according to claim 1, further comprising:
monitoring the first channel allocated to the proximity-based services within the cluster and the second channel allocated to the proximity-based services within the cluster; and
determining at least one of the monitored channels to be used for reception.

6. The method according to claim 1, wherein, after the indication of the second channel allocated to the proximity-based services within the cluster is received, the method further comprises:
transmitting an indication that the second channel is not needed anymore, if transmissions are received on the first channel allocated to the proximity-based services within the cluster.

7. An apparatus, comprising:
at least one processor; and
at least one memory including computer program code,
the at least one memory and the computer program code configured, with the at least one processor, to cause the apparatus at least to
monitor a first channel allocated to proximity-based services within a cluster;
transmit, if the apparatus is not receiving transmissions on the first channel, an indication that the receiving user device is not receiving transmissions on the first channel allocated to the proximity-based services within the cluster; and
receive an indication of a second channel allocated to the proximity-based services within the cluster.

8. The apparatus according to claim 7, wherein the second channel allocated to the proximity-based services within the cluster is a relaying channel for transmissions of a cluster head of the cluster.

9. The apparatus according to claim 7, wherein the indication is transmitted to a cluster head of the cluster.

10. The apparatus according to claim 7, wherein the apparatus is further caused to monitor at least one of the following: the first channel allocated to the proximity-based services within the cluster and the second channel allocated to the proximity-based services within the cluster.

11. The apparatus according to claim 7, wherein the apparatus is further caused to:
monitor the first channel allocated to the proximity-based services within the cluster and the second channel allocated to the proximity-based services within the cluster; and
determine at least one of the monitored channels to be used for reception.

12. The apparatus according to claim 7, wherein the apparatus is, after the indication of the second channel allocated to the proximity-based services within the cluster is received, further caused to:
transmit an indication that the second channel is not needed anymore, if transmissions are received on the first channel allocated to the proximity-based services within the cluster.

13. A method, comprising:
receiving an indication that a receiving user device is not receiving transmissions on a channel allocated for proximity-based services within a cluster;
monitoring the channel allocated for the proximity-based services within a cluster and whether the channel is not usable for the receiving user device; and
providing relaying services for proximity-based service transmissions to the receiving user device.

14. The method according to claim 13, further comprising:
providing the relaying services to at least one cluster member other than the receiving user device.

15. The method according to claim 13, wherein the providing of the relaying services further comprises allocating a channel for the relaying services.

16. The method according to claim 13, wherein the providing of the relaying services further comprises allocating a channel for the relaying services, the method further comprising:
receiving an indication that transmissions are received on the channel allocated for proximity-based services, and
releasing the channel allocated for the relaying services.

17. The method according to claim 13, further comprising:
providing the relaying services by using groupcasting and/or broadcasting.

18. An apparatus, comprising:
at least one processor; and
at least one memory including computer program code,
the at least one memory and the computer program code configured, with the at least one processor, to cause the apparatus at least to:
receive an indication that a receiving user device is not receiving transmissions on a channel allocated for proximity-based services within a cluster;
monitor the channel allocated for the proximity-based services within a cluster and whether the channel is not usable for the receiving user device; and
provide relaying services for proximity-based service transmissions to the receiving user device.

19. The apparatus according to claim 18, wherein the apparatus is further caused to provide the relaying services to at least one cluster member other than the receiving user device.

20. The apparatus according to claim 18, wherein the providing of the relaying services further comprises allocating a channel for the relaying services.

21. The apparatus according to claim 18, wherein the providing of the relaying services further comprises allocating a channel for the relaying services, the apparatus is further caused to:
receive an indication that transmissions are received on the channel allocated for proximity-based services, and
release the channel allocated for the relaying services.

22. The apparatus according to claim 18, wherein the apparatus is further caused to:
provide the relaying services by using groupcasting and/or broadcasting.
